(19) United States
(12) Patent Application Publication
(10) Pub. No.: US 2004/0167833 A1
(43) Pub. Date: Aug. 26, 2004

(54) Parts search system

(76) Inventor: John F. Schickler, Rochester, NY (US)

Correspondence Address: BROWN & MICHAELS, PC, 400 M & T BANK BUILDING, 118 NORTH TIOGA ST, ITHACA, NY, 14850, US

(21) Appl. No.: 10/781,961

(22) Filed: Feb. 19, 2004

Related U.S. Application Data
(60) Provisional application No. 60/449,542, filed on Feb. 21, 2003.
(60) Provisional application No. 60/508,987, filed on Oct. 6, 2003.

(51) Int. Cl. G06F 17/60

(52) U.S. Cl. 705/28

(57) ABSTRACT

This parts search system solves the problem of defining a correct part despite multiple definitions for replacement parts. The system employs a database or databases including: (a) the names, abbreviations, misspellings and word combinations for parts used in the assemblage of a device; (b) the possible manufacturers, parts and part numbers used in the assemblage of a device; and (c) applications, illustrations and other information related to the parts. A single code number, such as a VMRS code issued by the Technology and Maintenance Council of the American Trucking Associations, is assigned to each part. This code is used to link together and cross-reference all of the items in the database tables. Software is provided allowing the user to enter a multiplicity of choices of a word, abbreviation, misspelling, word combination, code, part number, and/or manufacturer and arrive at the correct part description, application, illustration and part number.

### REFERENCE TO RELATED APPLICATIONS

This application claims an invention which was disclosed in Provisional Application No. 60/449,542, filed Feb. 21, 2003, entitled “Parts Search System”, and Provisional Application No. 60/508,987, filed Oct. 6, 2003, entitled “Parts Search System”. The benefit under 35 USC §119(e) of these United States provisional applications is hereby claimed, and the aforementioned applications are hereby incorporated herein by reference.

### BACKGROUND OF THE INVENTION

1. Field of the Invention

This invention relates to computer assisted searches for correct replacement parts for vehicles and other equipment. More particularly, the invention pertains to a system allowing the user to enter a multiplicity of choices of a word, abbreviation, misspelling, word combination, code, part number, and/or manufacturer and arrive at the correct part description, application, illustration and part number.

2. Description of Related Art

In the selection of replacement parts for technical equipment such as vehicles, excavators, compressors, etc., the person responsible for proper parts selection is faced with the dilemma of multiple naming conventions for the same type of part. This dilemma arises from the fact that there is no fixed terminology standard for all vehicle and equipment manufacturers' use in their parts catalogs. Therefore, the parts selection process requires learning the separate terminology of each manufacturer in order to find proper parts. This often leads to wasted time and sometimes to improper parts selection with associated problems, including potential safety hazards.

A further complication is that sometimes several different names are used for the same part, even the part of a single manufacturer. For example, a Jacobs Brake is a valve cycle alteration device on a diesel engine which converts the engine into a compressor to aid in slowing the vehicle. The device is made by Jacobs Engine Brake Company. Various terms for this device are: Jake Brake, Engine Brake, Compression Brake, Exhaust Brake and Retarder. To confuse things even more, the last two could refer to a different part altogether.

A third complication in parts selection is that both manufacturers and parts users either abbreviate or misspell the names of replacement parts. For example, ABS is a common abbreviation for Antilock Brake System, but is also an abbreviation for Absorber. A vacuum break piston on a carburetor is often erroneously called a vacuum brake, which is a completely different part. Compressor is often spelled Compresser, and so forth.

There is currently no system that adequately overcomes these problems, including their potential for associated safety hazards.

### SUMMARY OF THE INVENTION

My invention solves the problem of defining a correct part despite the multiple names, designations, definitions and other identifiers used in association with appropriate replacement parts. The first step of my invention is the creation of a comprehensive database for any field of search—e.g. vehicle parts. This database has a lexicon containing a multiplicity of possible words, abbreviations, misspellings, word combinations and other identifiers that might be used in finding parts in the field. The database also contains a listing of all manufacturers' parts in the field with their associated manufacturer's part numbers (which can also serve as identifiers).

At this point, all of the possible terms for parts and all of the possible parts that might fit those terms are set forth in the database. The next thing that is needed is a way for the user to connect these two in a useful way. I do this by using a single code distinctive from the various manufacturers' part numbers to designate a particular part, no matter what manufacturers produce that part, and how it is named or identified by the manufacturer or the public. Each term in the lexicon is also linked to one or more codes related to possible parts that could be designated by that word. Thus, in my system, one could begin with almost any identifier and immediately find all of the possible parts (including those located in different vehicle systems and/or produced by different manufacturers) that might fit that identifier.

In effect, the code provides a single correct definition of a manufacturers' part for the multiplicity of possible identifiers used in association with that part. The codes which are used are a published industry standard—the VMRS codes (“Vehicle Maintenance Reporting Standards”) as issued by the Technology and Maintenance Council of the American Trucking Associations, Washington DC. These same codes are then applied in other ways for the benefit of the user, including links to correct descriptions, applications and illustrations of the part. A software package arranges the above combinations in window lists and allows the user to begin with words, abbreviations, misspellings, word combinations, part numbers, codes or other identifiers in order to arrive at a single selection of part descriptions for any manufacturer. The associated definition codes are also displayed.

### BRIEF DESCRIPTION OF THE DRAWINGS

FIGS. 1-5 illustrate some of the problems associated with prior art word searches.

FIG. 1 illustrates a sample screen showing the initiation of a computer word search for the word VISOR.

FIG. 2 illustrates a sample screen showing the selection of manufacturers resulting from the search for the word VISOR shown in FIG. 1.

FIG. 3 illustrates a sample screen resulting from clicking on one manufacturer, General Motors, in FIG. 2.

FIG. 4 illustrates a sample screen resulting from clicking on another manufacturer, International.

FIG. 5 illustrates a sample screen resulting from clicking on another manufacturer, New Holland.

FIGS. 6-14 illustrate the use and benefits of my system, including its ability to overcome the problems associated with prior art word searches.

FIG. 6 illustrates a sample screen where an abbreviation for compressor, COMP, has been entered as the “part number” (or identifier) by a user in a search for an appropriate replacement part for an air conditioning compressor.

FIG. 7 illustrates a sample screen resulting from a search of COMP with numerous manufacturers of COMP being presented.

FIG. 8 illustrates a sample screen resulting from clicking on NVSTR in FIG. 7 and also clicking on code 001001002 in the Vehicle Systems window of FIG. 8, showing that this is the code for an air conditioning compressor.

FIG. 9 illustrates a sample screen resulting from clicking on code 013009001 in the Vehicle Systems window of FIG. 8, showing that this code is for an air brake compressor.

FIG. 10 illustrates a sample screen resulting from searching the code 001001002 for the manufacturer International.

FIG. 11 illustrates a sample screen resulting from clicking on the Figure number 001SV in FIG. 10.

FIG. 12 illustrates a sample screen resulting from clicking on the Figure number 001SV in FIG. 10.

FIG. 13 illustrates a sample screen resulting from selecting the part number to be matched 2000820691 from FIG. 12.

FIG. 14 illustrates a sample screen resulting from a search of the part number to be matched 2000820691, with windows providing the correct Vehicle System Code, Description, Applications, and other information, including Primary CrossReference part numbers.

FIG. 15 provides a basic schematic illustration of the components and process used in my invention.

FIGS. 16-20 provide more detailed schematic illustrations of the components and processes used in my invention.

FIG. 16 provides process diagrams for searches initiated by using a component word description and noting the vehicle or component manufacturer and thereafter entering component application per vehicle model and/or system per vehicle manufacturer.

FIG. 17 provides process diagrams for searches initiated by using a component word description and noting the vehicle or component manufacturer and thereafter entering a vehicle serial number or assigned identification number.

FIG. 18 provides process diagrams for searches initiated by using an abbreviation or other terminology as a component word description and noting the vehicle or component manufacturer and thereafter entering component application per vehicle model and/or system per vehicle manufacturer.

FIG. 19 provides process diagrams for searches initiated and pursued in the manner shown in FIG. 16, but continuing with the provision of illustrations.

FIG. 20 provides process diagrams for searches initiated and pursued in the manner shown in FIG. 16, but continuing with the posting of part numbers and VMRS codes to an electronic file, and electronic searching for and posting of prices, inventory, locations and order quantities for the part numbers originally searched.

### DETAILED DESCRIPTION OF THE INVENTION

As previously noted, the parts selection process currently requires learning the separate terminology of each manufacturer in order to find proper parts, which often leads to wasted time and sometimes to improper parts selection. In addition, various identifiers are sometimes used to define the same manufacturer's part. Finally, both manufacturers and parts users either abbreviate or misspell the names of replacement parts. Given the foregoing facts, finding the proper part can be an extremely difficult process.

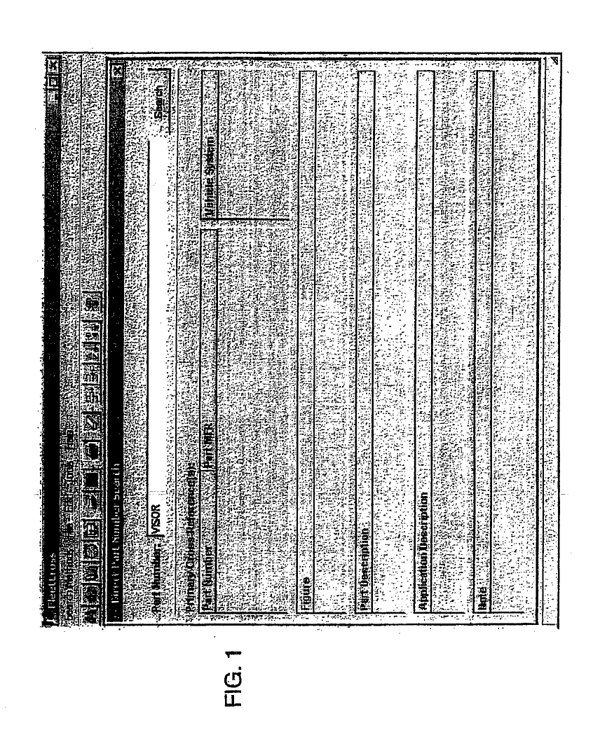

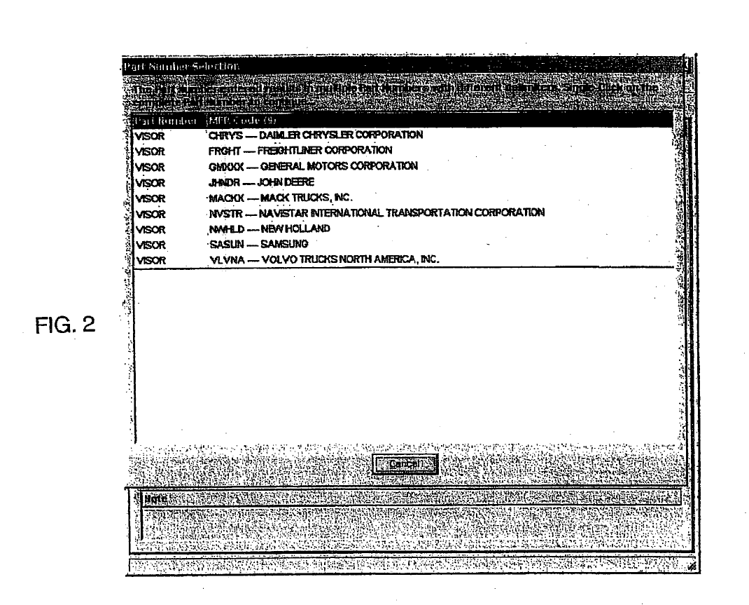

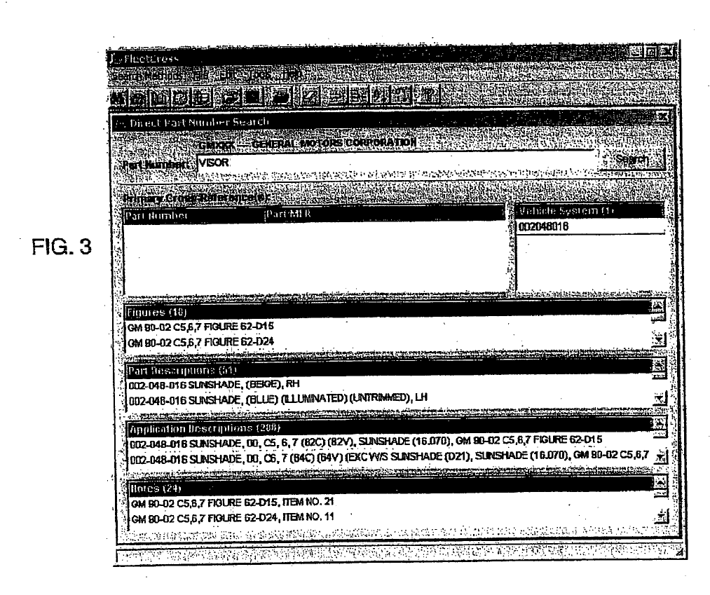

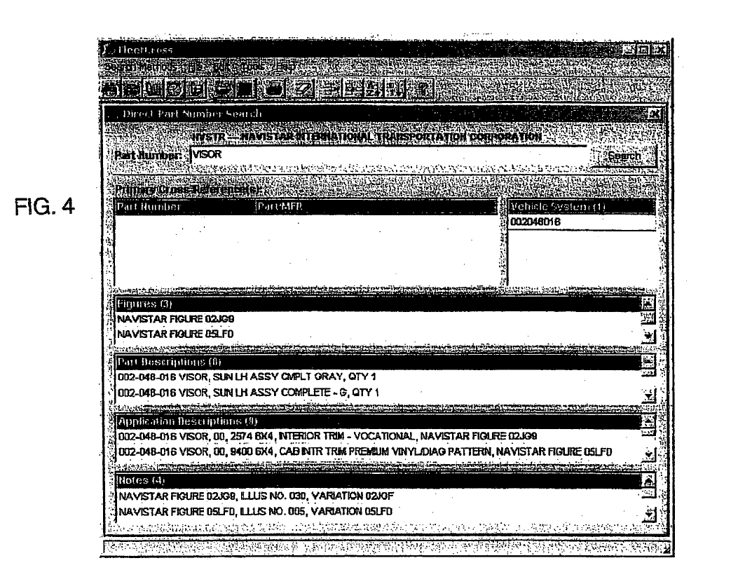

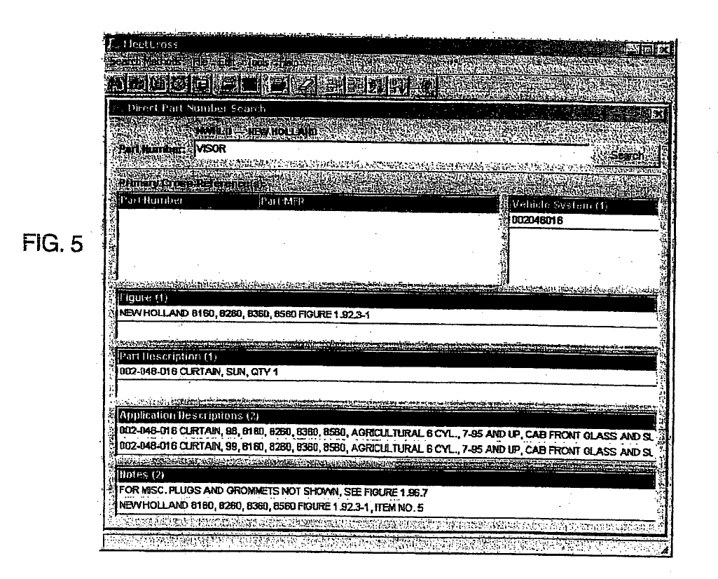

An example of the difficulties in this process can be seen in the sequence illustrated in FIGS. 1-5. In FIG. 1 a search for the word VISOR is initiated. FIG. 2 illustrates a selection of manufacturers resulting from the aforesaid search. In FIG. 3, we see that one manufacturer, General Motors, refers to VISOR as a SUNSHADE. However, as illustrated by FIG. 4, International refers to VISOR as VISOR, SUN. Finally, in FIG. 5, we find that New Holland refers to VISOR as CURTAIN, SUN. In addition, two of the three manufacturers do not indicate whether the VISOR is interior or exterior.

My invention solves the problem of defining a correct part despite multiple definitions for replacement parts by cross-referencing all possible identifiers, such as possible part names, manufacturers for each part, manufacturer's part numbers, manufacturer's figures showing that part, and other information to a single definition code defining that part. A software package provides screen windows displaying the above combinations in lists/tables. It also allows the user to enter almost any identifier, including words, abbreviations, misspellings, word combinations, manufacturer part numbers or codes as a “part number” in order to arrive at a single selection of part descriptions for any manufacturer. The associated definition codes are also displayed.

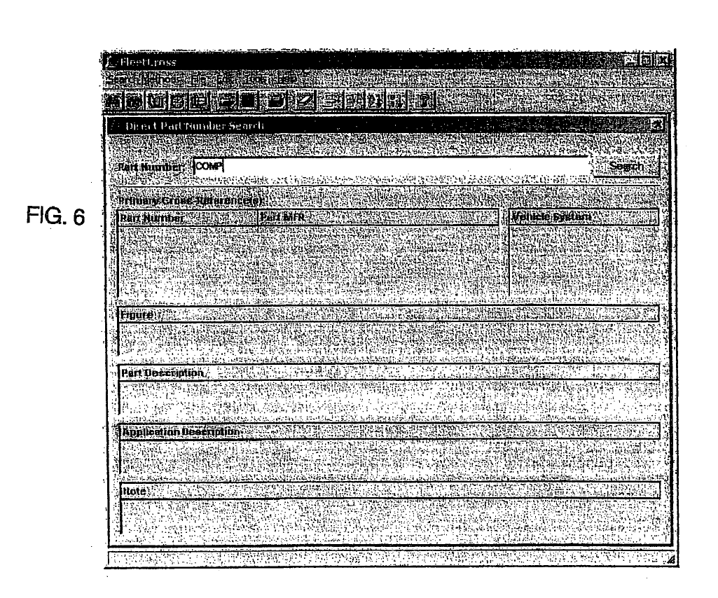

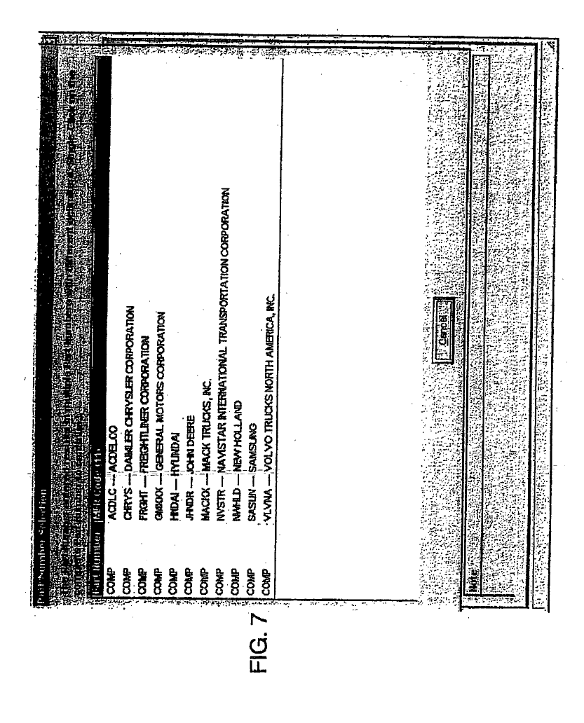

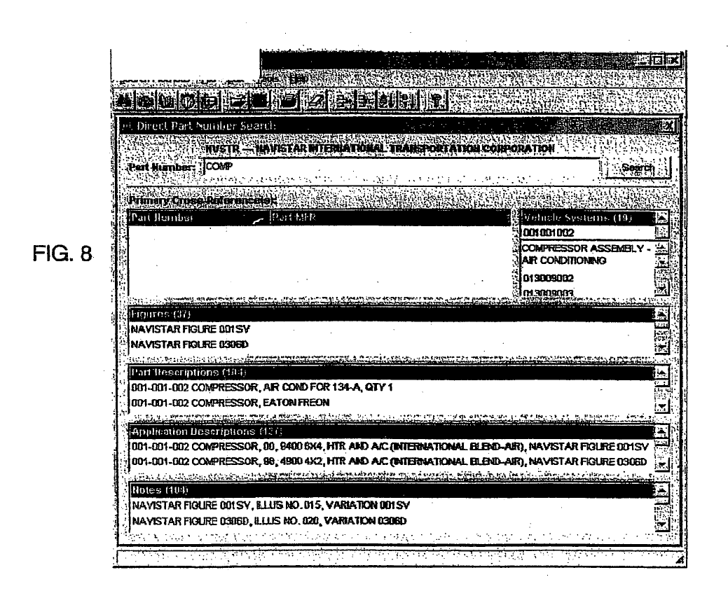

For example, on the screen shown in FIG. 6, an abbreviation for compressor, COMP, has been entered as the “part number” by a user in a search for an appropriate replacement part for an air conditioning compressor. (A manufacturer's part number or a code could also be entered.) On the screen shown in FIG. 7, a search of COMP results in numerous manufacturers of COMP being presented. By clicking on NVSTR, the abbreviation for International, all of International's compressor parts descriptions are presented. (See, FIG. 8). As will be seen in a review of FIG. 8, my invention provides all of the codes (a total of 19) cross-referenced to “COMP” for this manufacturer in the “vehicle systems” window. It also provides windows listing the manufacturer's figures (totaling 37), part descriptions (totaling 104), application descriptions (totaling 127), and notes (totaling 104). All of the foregoing are cross-referenced via the definition codes to the lexicon entry “COMP” for the manufacturer “International”.

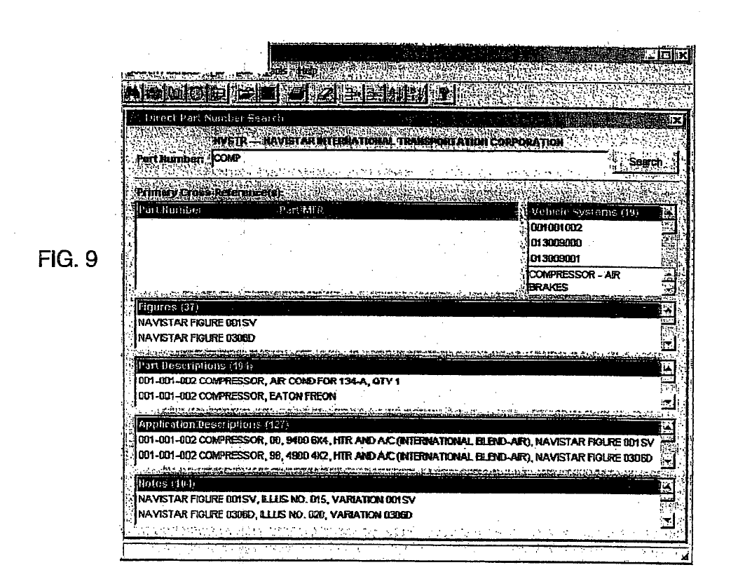

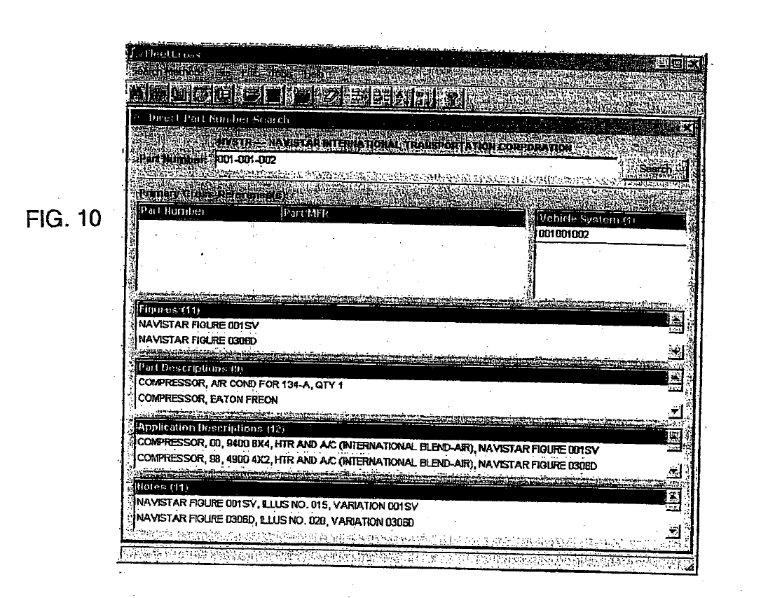

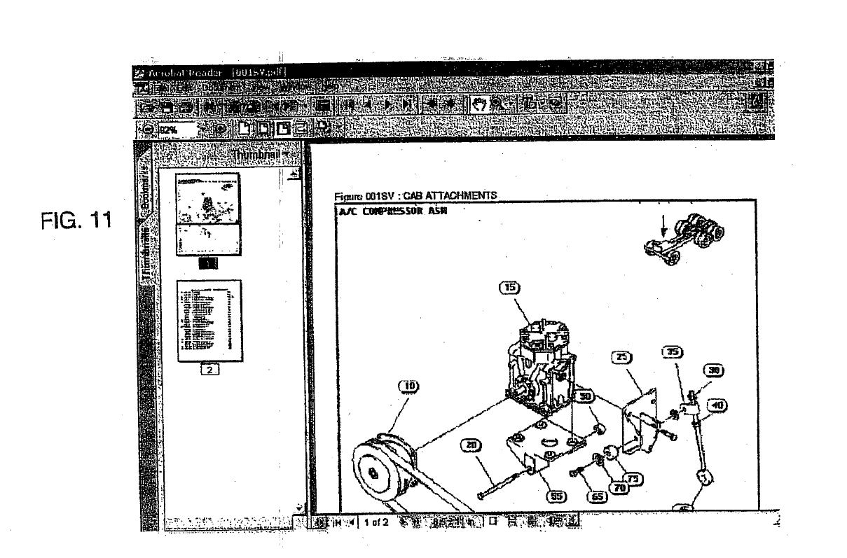

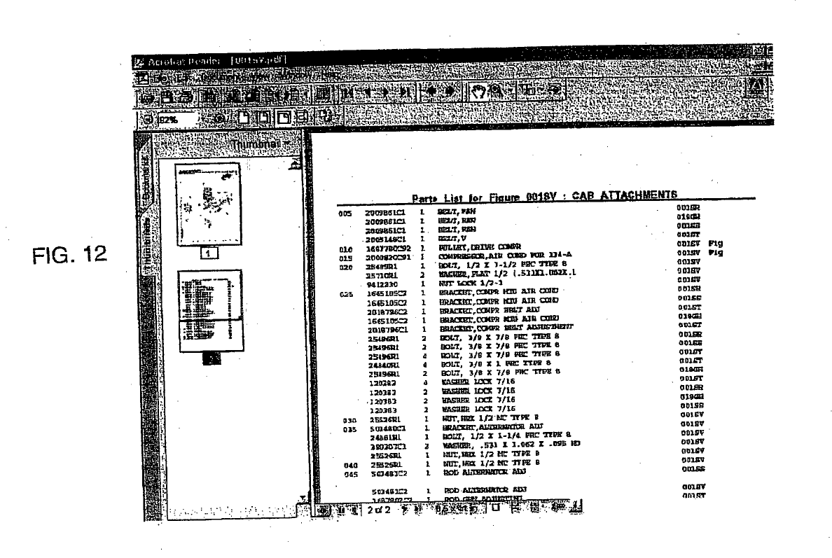

In the Vehicle Systems window, the various definition codes can also be “clicked” for further information. Thus, on the screen shown in FIG. 8, code 001001002 has been clicked to show that it is the code for an air conditioning compressor. (Likewise, on the screen shown in FIG. 9, clicking on code 013009001 shows that this code is for an air brake compressor.) As the user is searching for an air conditioning compressor part, he/she would next enter the code given above as a part number. The results for this step are shown in FIG. 10, where the code 001001002 has been searched for International. The parts listed are now entirely those related to air-conditioning compressors. Now the user can begin to focus in on the appropriate model and year for the part. Thus, turning to the Applications Descriptions window, the user can select an appropriate model and year, such as the first entry under this heading (a year 2000 9400 6X4). As will be noted, the proper Figure for this model (“001SV”), is defined for this model and year in the Applications Descriptions window. By clicking on that number in the Figures window, the manufacturer's illustration and associated part numbers are displayed, as seen on the screen shown in FIG. 11 and the screen shown in FIG. 12.

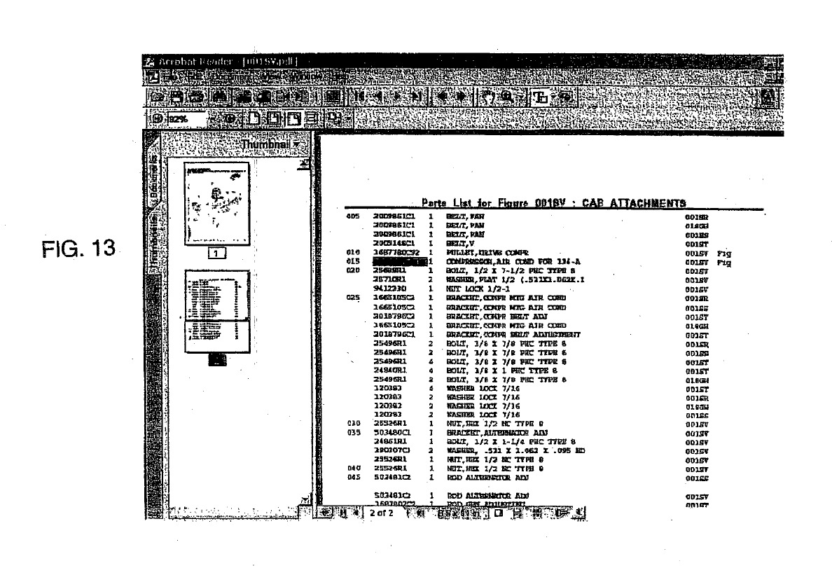

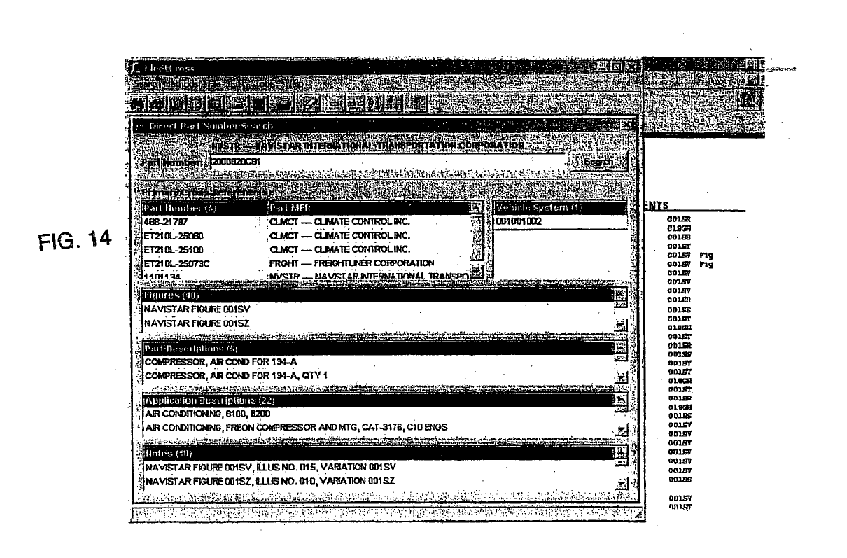

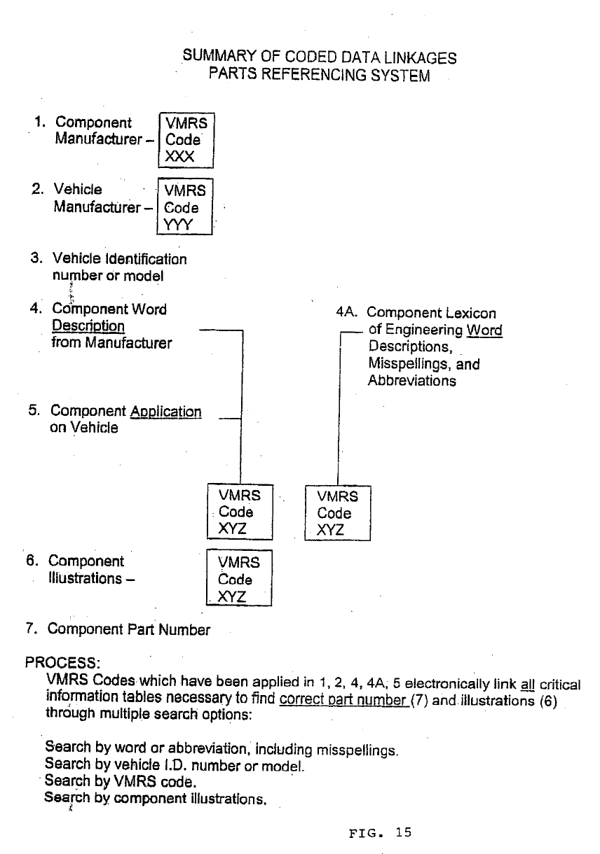

From the illustration shown in FIG. 1 the user can pick out the part to be matched such as the part designated “15” in the illustration and find its matching manufacturer's part number (as seen in FIG. 13) of 2000820691. Searching this number (as the part number) in the screen shown in FIG. 14 brings up windows providing the correct Vehicle System Code, Description, Applications, etc. as well as providing Primary Cross-Reference part numbers (i.e.-equivalent replacement parts made by other manufacturers). Therefore, what had started as a multiplicity of word selections has been refined to one part number choice (and equivalents) by using my system.

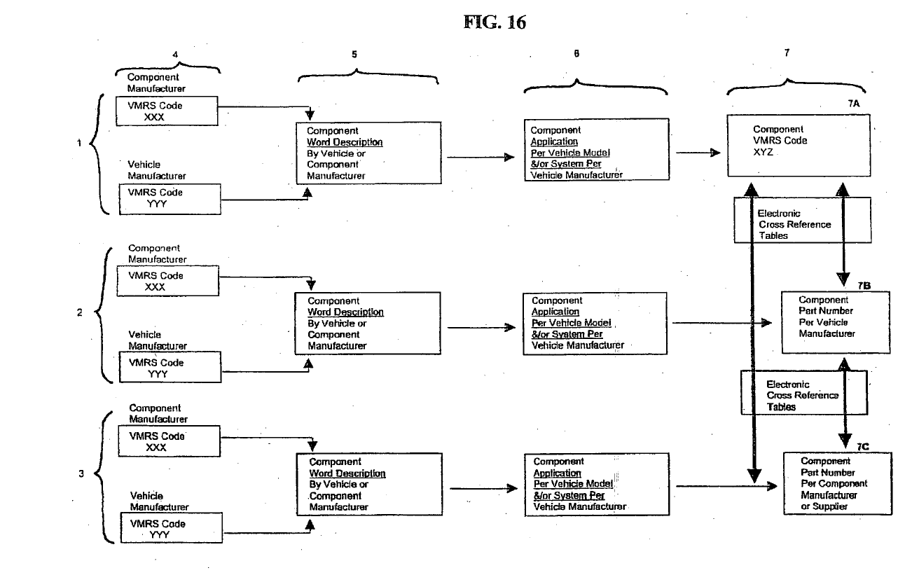

FIGS. 16 through 20 provide process diagrams further illustrating the features and advantages of my invention. In these figures, certain tracks including multiple process steps are set forth horizontally and are designated generally in each figure by brackets 1, 2, and 3. In track 1, a component VMRS code is sought. In track 2, a component part number as used by the vehicle manufacturer is sought. And, in track 3, a component part number used by the component manufacturer or supplier is sought.

In addition, certain process steps or analogous steps repeated in each track in FIGS. 16 through 20 appear in the same vertical column with such columns designated in each figure by brackets 4, 5, 6 and 7. Thus, in FIGS. 16 through 20, the first column represents preexisting data sets providing the codes (preferably VMRS codes) for component manufacturers and vehicle manufacturers and is designated generally by a bracket 4. A second column represents steps associated with the initial entry of an identifier and is designated generally by a bracket 5. A third column represents certain steps subsequent to the initial entry of an identifier and is designated generally by a bracket 6. And, a fourth column indicates results obtained and is indicated by a backet 7.

FIG. 16 provides initial process diagrams for searches initiated by using a component word description as an initial identifier. As noted above, track 1 is aimed at obtaining the VMRS code for the component, track 2 is aimed at obtaining a component part number used by the vehicle manufacturer, and track 3 is aimed at obtaining a component part number used by the component manufacturer or supplier. Inquiries in all three tracks shown in FIG. 16 are initiated at column 5 by the entry of a component word description and entering the vehicle or component manufacturer.

This leads to the next step, indicated at column 6, where the component application per vehicle model and/or system per vehicle manufacturer is entered. This in turn leads to the VMRS code sought (as indicated at box 7A for track 1), the component part number used by the vehicle manufacturer (as indicated at box 7B or track 2), or the component part number used by the component manufacturer or supplier (as indicated at box 7C for track 3). All of these are cross-linked via electronic cross reference tables via the VMRS code, such that all three can be obtained from the others after arriving at this point in the process. (See, FIGS. 16 through 20 at column 7).

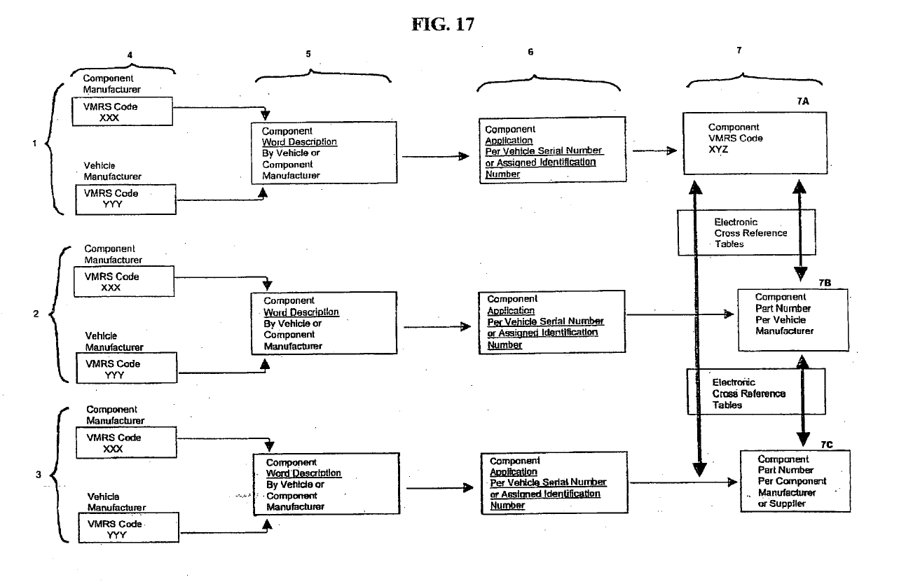

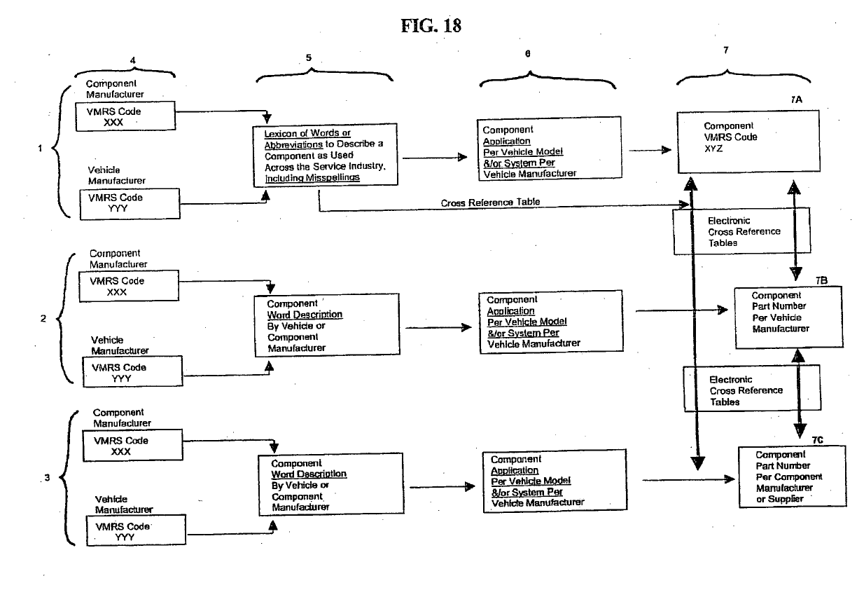

FIGS. 17 and 18 slightly vary the basic pattern illustrated in FIG. 16. FIG. 17 provides process diagrams for searches initiated by using a component word description as an identifier and noting the vehicle or component manufacturer. (See, FIG. 17 at column 5). However, in FIG. 17 a vehicle serial number or assigned identification number is entered next rather than the component application per vehicle model and/or system per vehicle manufacturer. (See, FIG. 17 at column 6). Thereafter, the end results in column 7 are parts that are specific to the vehicle serial number. FIG. 18 differs from FIG. 16 in that it provides process search diagrams for searches initiated by using an abbreviation or other terminology as a component word description or identifier. (See, FIG. 18 at column 5, track 1).

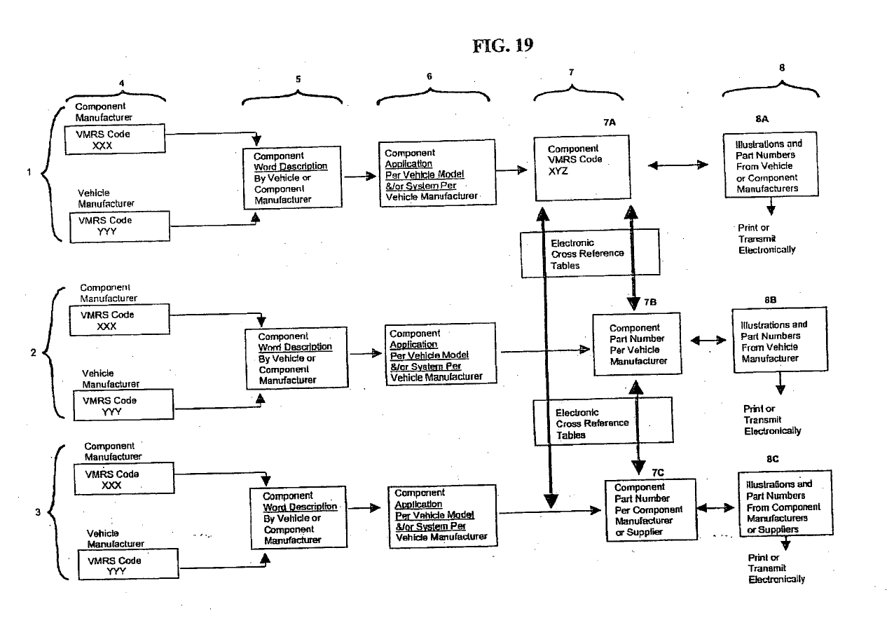

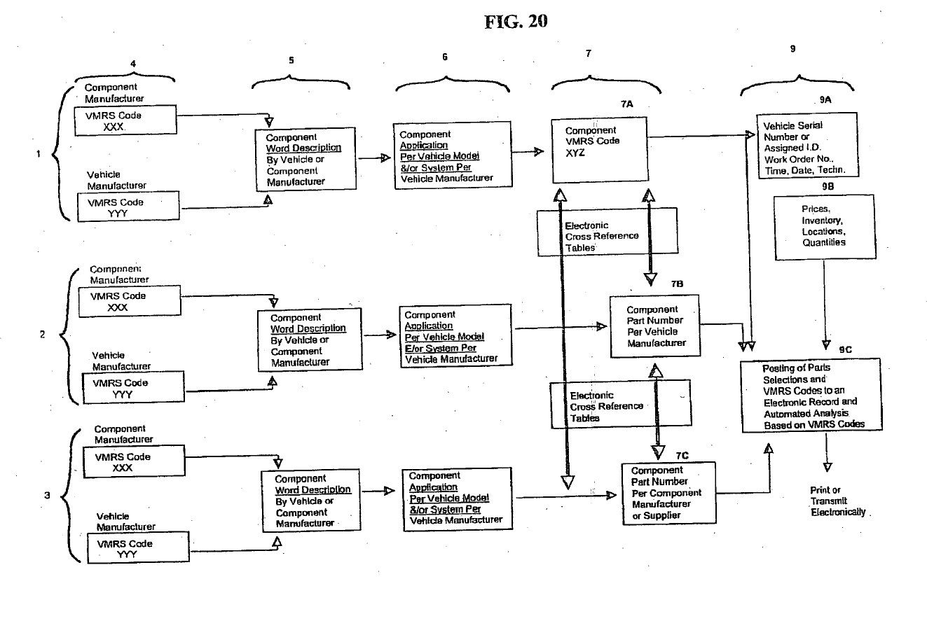

FIGS. 19 and 20 illustrate further steps that can be taken in my invention after those outlined in column 7. FIG. 19 continues past column 7 to the provision of illustrations with part numbers that can be printed or electronically transmitted. (See, FIG. 19 at column 8). All illustrations of a part number application are shown as a direct linkage without a separate search. FIG. 20 provides process diagrams for searches initiated and pursued in the manner shown in FIG. 16, but continuing with other functions such as the posting of part numbers and VMRS codes to an electronic file which can be printed, electronically transmitted or analyzed for vehicle history per VMRS code applications. (See, FIG. 20 at column 9, Box 9C). And, the posting of prices, inventory, locations and order quantities for the part numbers originally searched and denoted in boxes 7B and 7C. (See, FIG. 20 at column 9, Box 9B).

In summarizing all of the foregoing, it is clear that my invention comprehends:

1. The creation of database(s) including for parts used in the assemblage of a device: (a) identifiers such as possible manufacturers, part numbers, and user names (including abbreviations, misspellings and word combinations for parts); and (b) applications, illustrations and other information related to the parts.

2. The assignment of a single code number to each part, no matter what its manufacturer, manufacturer's part number, manufacturer's description, user's description, or other identifiers.

3. Using the single code for each part to link together and cross-reference all of the items in the database.

4. Providing a software system allowing the user to enter a multiplicity of identifiers, including words, abbreviations, misspellings, word combinations, codes, part numbers, and/or manufacturers and arrive at the correct part description, application, illustration and part number.

However, it is to be understood that the inventive concepts underlying and embodied in my invention can be incorporated in different forms so that the general concepts described in the preceding description are not to be superseded by the particularity of the attached drawings. Various alterations, modifications, and/or additions can be made without departing from the spirit or ambit of the invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for making a parts search, comprising:
compiling a computer accessible database, said database including a listing of parts used in the assemblage of a device, possible identifiers for each such part, and information related to each such part with a single Code being assigned and linked to each part, all identifiers for that part and all information related to that part; and
providing a computer program for accessing and processing information from the aforesaid database, the program allowing the user to search said database using an identifier, and presenting the user in response to said search with all information linked via the Code to the identifier searched.

2. A method for making a parts search as described in claim 1, wherein said identifiers include at least one from a group including possible manufacturers for that part, possible Codes for that part, possible manufacturers' part names for that part, possible manufacturer's part numbers for that part, and possible user names for that part, which possible user names also include possible abbreviations, name misspellings and word combinations used for that part.

3. A method for making a parts search as described in claim 2, wherein said information related to each such part includes at least one from a group including possible manufacturer's for that part, possible Codes for that part, possible manufacturers' part names for that part, and possible manufacturer's part numbers for that part.

4. A method for making a parts search as described in claim 3, wherein said other information further includes at least one from a group including possible part descriptions, possible part applications, and possible part illustrations.

5. A method for making a parts search as described in claim 4, wherein a search of a possible user name for a part initially results in a listing of manufacturers linked to said user name.

6. A method for making a parts search as described in claim 5, wherein clicking on one of the manufacturers listed results in a listing of information in the database related to parts of that manufacturer linked to said user name.

7. A method for making a parts search as described in claim 6, wherein said listing of information includes a listing of part descriptions for parts of that manufacturer linked to said user name.

8. A method for making a parts search as described in claim 6, wherein said listing of information includes a listing of Codes for parts of that manufacturer linked to said user name.

9. A method for making a parts search as described in claim 8, wherein clicking on one of the Codes listed results in a description of the part denoted by that Code.

10. A method for making a parts search as described in claim 6, wherein said listing of information includes a listing of manufacturer's illustrations including parts of that manufacturer linked to said user name.

11. A method for making a parts search as described in claim 6, wherein said listing of information includes a listing of application descriptions for parts of that manufacturer linked to said user name.

12. A method for making a parts search as described in claim 4, wherein a search of a Code with reference to a particular manufacturer results in a listing of information in the database related to parts of that manufacturer linked to said Code.

13. A method for making a parts search as described in claim 12, wherein said listing of information includes a listing of part descriptions for parts by the manufacturer linked to said Code.

14. A method for making a parts search as described in claim 12, wherein said listing of information includes a listing of illustrations by the manufacturer including parts linked to said Code.

15. A method for making a parts search as described in claim 12, wherein said listing of information includes a listing of application descriptions for parts of that manufacturer linked to said Code.

16. A method for making a parts search as described in claim 14, wherein clicking on one of the illustrations listed brings up the illustration on the computer screen for review by the user.

17. A method of making a parts search as described in claim 14, wherein clicking on a part number in one of the illustrations listed brings up a data screen describing that part, said description including at least one of a group including manufacturers for that part, associated codes, and cross references to equivalent part numbers and their manufacturers.

18. A method for making a parts search as described in claim 4, wherein a search of a part number with reference to a particular manufacturer results in a listing of information in the database related to that part.

19. A method for making a parts search as described in claim 18, wherein the information includes a listing of equivalent replacement parts and the manufacturers of such parts.

20. A method for making a parts search as described in claim 1, wherein information linked via the code to the identifier searched includes at least one of a vehicle identification number, a fleet unit number, and a model designation.

21. A method for making a parts search as described in claim 5, wherein said search also initially results in a listing of possible vehicles by at least one of a vehicle identification number, a model designation, and a fleet unit number.

22. A method for making a parts search as described in claim 8, wherein clicking on one of the codes listed results in a description of the part denoted by that code and its application.

23. A method for making a parts search as described in claim 6, wherein said listing of information includes a listing of application descriptions and possible codes for parts of that manufacturer linked to said user name.

24. A method for making a parts search as described in claim 4, wherein a search of a code with reference to a particular manufacturer results in a listing of information in the database related to parts of that manufacturer and their applications linked to said code.

25. A method for making a parts search as described in claim 12, wherein said listing of information includes a listing of illustrations by the manufacturer including parts linked to said code and said listing of information is accomplished by placement of said code or an electronic equivalent on said illustration pages.

26. A method for making a parts search, comprising:
compiling a computer accessible database, said database including a listing of parts used in the assemblage of a device, possible identifiers for each such part, and information related to each such part with a single VMRS Code being assigned and linked to each part, all identifiers for that part and all information related to that part; and
providing a computer program for accessing and processing information from the aforesaid database, the program allowing the user to search said database using an identifier, and presenting the user in response to said search with all information linked via the VMRS Code to the identifier searched.

27. A method for making a parts search as described in claim 26, wherein said identifiers include at least one from a group including possible manufacturers for that part, possible VMRS Codes for that part, possible manufacturers' part names for that part, possible manufacturer's part numbers for that part, and possible user names for that part, which possible user names also include possible abbreviations, name misspellings and word combinations used for that part.

28. A method for making a parts search as described in claim 27, wherein said information related to each such part includes at least one from a group including possible manufacturer's for that part, possible VMRS Codes for that part, possible manufacturers' part names for that part, and possible manufacturer's part numbers for that part.

29. A method for making a parts search as described in claim 28, wherein said other information further includes at least one from a group including possible part descriptions, possible part applications, and possible part illustrations.

30. A method for making a parts search as described in claim 29, wherein a search of a possible user name for a part initially results in a listing of manufacturers linked to said user name.

31. A method for making a parts search as described in claim 30, wherein clicking on one of the manufacturers listed results in a listing of information in the database related to parts of that manufacturer linked to said user name.

32. A method for making a parts search as described in claim 31, wherein said listing of information includes a listing of part descriptions for parts of that manufacturer linked to said user name.

33. A method for making a parts search as described in claim 31, wherein said listing of information includes a listing of VMRS Codes for parts of that manufacturer linked to said user name.

34. A method for making a parts search as described in claim 33, wherein clicking on one of the VMRS Codes listed results in a description of the part denoted by that VMRS Code.

35. A method for making a parts search as described in claim 31, wherein said listing of information includes a listing of manufacturer's illustrations including parts of that manufacturer linked to said user name.

36. A method for making a parts search as described in claim 31, wherein said listing of information includes a listing of application descriptions for parts of that manufacturer linked to said user name.

37. A method for making a parts search as described in claim 29, wherein a search of a VMRS Code with reference to a particular manufacturer results in a listing of information in the database related to parts of that manufacturer linked to said VMRS Code.

38. A method for making a parts search as described in claim 37, wherein said listing of information includes a listing of part descriptions for parts by the manufacturer linked to said VMRS Code.

39. A method for making a parts search as described in claim 37, wherein said listing of information includes a listing of illustrations by the manufacturer including parts linked to said VMRS Code.

40. A method for making a parts search as described in claim 37, wherein said listing of information includes a listing of application descriptions for parts of that manufacturer linked to said VMRS Code.

41. A method for making a parts search as described in claim 39, wherein clicking on one of the illustrations listed brings up the illustration on the computer screen for review by the user.

42. A method of making a parts search as described in claim 39, wherein clicking on a part number in one of the illustrations listed brings up a data screen describing that part, said description including at least one of a group including manufacturers for that part, associated codes, and cross references to equivalent part numbers and their manufacturers.

43. A method for making a parts search as described in claim 29, wherein a search of a part number with reference to a particular manufacturer results in a listing of information in the database related to that part.

44. A method for making a parts search as described in claim 43, wherein the information includes a listing of equivalent replacement parts and the manufacturers of such parts.

45. A method for making a parts search as described in claim 26, wherein information linked via the VMRS Code to the identifier searched includes at least one of a vehicle identification number, a fleet unit number, and a model designation.

46. A method for making a parts search as described in claim 30, wherein said search also initially results in a listing of possible vehicles by at least one of a vehicle identification number, a model designation, and a fleet unit number.

47. A method for making a parts search as described in claim 33, wherein clicking on one of the VMRS Codes listed results in a description of the part denoted by that VMRS Code and its application.

48. A method for making a parts search as described in claim 31, wherein said listing of information includes a listing of application descriptions and possible VMRS Codes for parts of that manufacturer linked to said user name.

49. A method for making a parts search as described in claim 29, wherein a search of a VMRS Code with reference to a particular manufacturer results in a listing of information in the database related to parts of that manufacturer and their applications linked to said VMRS Code.

50. A method for making a parts search as described in claim 37, wherein said listing of information includes a listing of illustrations by the manufacturer including parts linked to said VMRS Code and said listing of information is accomplished by placement of said VMRS Code or an electronic equivalent on said illustration pages.
